(19) United States
(12) Patent Application Publication
(10) Pub. No.: US 2005/0179554 A1
(43) Pub. Date: Aug. 18, 2005

(54) Advertising light-box network system with auto-detection and auto-monitor

(75) Inventor: Tai-Wen Lu, Shulin City (TW)

Correspondence Address: APEX JURIS, PLLC, 13194 EDGEWATER LANE NORTHEAST, SEATTLE, WA, 98125, US

(73) Assignee: Safe Fire Protection Equipment, Shulin City (TW)

(21) Appl. No.: 10/778,376

(22) Filed: Feb. 13, 2004

(51) Int. Cl. G08B 21/00

(52) U.S. Cl. 340/641; 340/635

(57) ABSTRACT

A advertising light-box network system with auto-detection and auto-monitor primarily is a system that installs a detection device in each advertising light-box of each area to detect whether a lamp body, a power supply device, or a control circuit board in the advertising light-box is abnormal, and send messages detected to a message receiving server of the area thereof for displaying, such that a maintenance worker of the area can get the real-time status of each advertising light-box in the area; and messages received by the message receiving server are sent by the message receiving server to a remote monitor server via internet to be converged and displayed on a remote display, thus a remote supervisor can get the status of all advertising light-boxes in all areas to achieve the object of real-time maintenance; also, the remote monitor server can send messages to a cellular phone, a PDA, or a notebook of a supervisor via a communication network so that the supervisor can 24-hour monitor the advertising light-boxes in all areas.

### BACKGROUND OF THE INVENTION

1. Field of the Invention

The present invention relates to an advertising light-box network system with auto-detection and auto-monitor, particularly to an advertising light-box network system with auto-detection and auto-monitor which can perform the 24-hour monitoring of advertising light-boxes in a manner of remote-monitoring and remote-displaying.

2. Description of the Prior Art

In general, an advertising light-box usually is disposed at a public place with a large stream of people to achieve the optimal effect of advertisement. Taken a MRT system as an example, several advertising light-boxes are disposed in each station. Each advertising light-box, independent with each other, includes a lamp body, a control circuit board, a power supply device, etc., such that the advertising light-box can illuminate a advertisement panel, via the lamp body driven by the control circuit board to illuminate the advertisement panel, to achieve the effect of product advertisement.

Although an advertising light-box has the advertisement effect, it still requires a lamp body as a light source to achieve this effect. If the lamp body, the control circuit board, or the power supply device in the advertising light-box is damaged, then the advertising light-box will fail to provide the advertisement effect. In order to eliminate this fault, a conventional method applies a solution that requires a worker to perform a checking round of the advertising light-boxes in all stations and fixing the failed. However, such a method requires a lot of human power and has low economic benefit. And, the way of manual checking easily brings up faults such as low efficiency, likely mistakes, etc., caused by the problems such as fatigue, ignorance, and the like. Furthermore, since the failure time of an advertising light-box is uncertain, if it fails just after the checking round such that it can not be fixed immediately.

Accordingly, it can be seen that the above-described conventional technique still has many drawbacks, and are not designed well, and need to be improved badly.

In view of disadvantages derived from the above-described conventional method for checking advertising light-boxes, the present inventor had devoted to improve and innovate, and, after studying intensively for years, developed successfully an advertising light-box network system with auto-detection and auto-monitor according to the invention.

### SUMMARY OF THE INVENTION

The object of the present invention is to provide an advertising light-box network system with auto-detection and auto-monitor which can 24-hour monitor advertising light-boxes to achieve the object of just-in-time maintenance.

The other object of the present invention is to provide an advertising light-box network system with auto-detection and auto-monitor which can remotely monitor the advertising light-boxes to achieve the object of labor cost saving.

The advertising light-box network system with auto-detection and auto-monitor which can achieve the above-mentioned objects includes advertising light-boxes, detection devices, message-receiving servers, a remote monitor system, and a remote display. Each area has several advertising light-boxes, and each advertising light-box has a detection device. In each advertising light-box, the detection device can detect a lamp body, a circuit board, and a power supply device whether the lamp body, the circuit board, and the power supply device is abnormal and send the detected message to a message receiving server of area thereof. Not only the message receiving server can show the condition of the advertising light-boxes in the area thereof, but also can send and converge messages to a remote monitor server. At the remote monitor server, the status of all advertising light-boxes in all areas can be shown in a remote display and printed by a printer. The remote monitor server can send messages to a cellular phone, a PDA, a notebook, or other potable communication product of a supervisor via a communication network so that the object of remote monitor can be achieved and the fault of conventional checking round of advertising light-boxes can be further improved.

These features and advantages of the present invention will be fully understood and appreciated from the following detailed description of the accompanying Drawings.

### BRIEF DESCRIPTION OF THE DRAWINGS

FIG. 1 shows the first architecture of an advertising light-box network system with auto-detection and auto-monitor according to the present invention; and

FIG. 2 shows the second architecture of an advertising light-box network system with auto-detection and auto-monitor according to the present invention.

### DETAILED DESCRIPTION OF THE PREFERRED EMBODIMENT

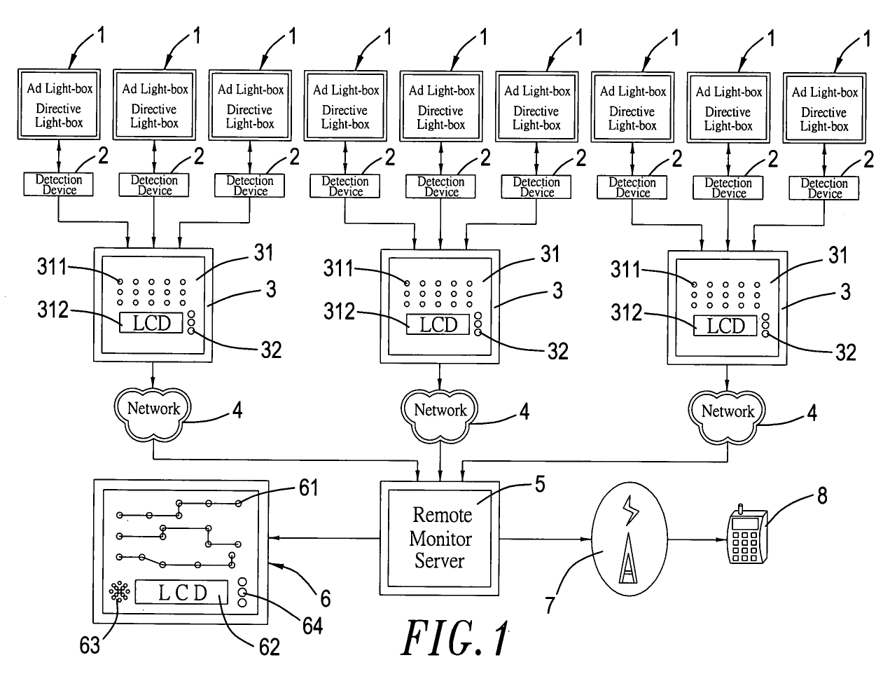

The first architecture of an advertising light-box network system with auto-detection and auto-monitor according to the present invention shown in FIG. 1 primarily includes:

Advertising light-boxes 1, each advertising light-boxes 1 is disposed in an area and each area has several advertising light-boxes 1, and each advertising light-box 1 comprises a lamp body, a control circuit board, and a power supply device such that the lamp body illuminating an advertisement panel to achieve the advertisement effect;
A detection device 2, installed in each advertising light-box 1, can detect the abnormal signal of the lamp body, the circuit board, or the power supply device of the advertising light-box 1, and send the result of detection to a message receiving server 3 by wire or wireless transmission, the wireless transmission can be radio-frequency, infrared, Bluetooth, or other wireless transmission;
A message receiving server 3, disposed in each area in which just one message receiving server 3 is disposed, the front of a message receiving server 3 has a display 31, the disply 31 can be a LED panel 311 or a LCD display 312 or both, and a memory is disposed in the message receiving server 3 for storing the abnormal data of the area thereof, a control button 32 is disposed on the message receiving server 3 for the operation and control of the display 31, and an additional detection loop device (not shown) can be installed in the message receiving server 3. the detection loop device can monitor whether the operation of the detection device 2 is abnormal, whether the circuit is short, and the like, to minimize the error chance; the message receiving server 3 receives messages from the detection device 2, and shows the received messages on the display 31 of the message receiving server 3, thus each abnormal advertising light-box of the area can be well informed timely and a message can be sent to a remote monitor server 5 via internet; if the display 31 of the message receiving server 3 is a LED panel 311, the twinkling or color of the LED can be used for indicating which advertising light-box is abnormal; if the display 31 of the message receiving server 3 is a LCD display 312, the LCD display 312 can be used for displaying abnormal advertising light-boxes directly and enquiring the abnormal history data; furthermore, if both the LED panel 311 and the LCD display are used, then the color of the LED panel can indicate which advertising light-box is abnormal and also the LCD display 312 can list the abnormal history data;

A remote monitor server 5, receiving messages from each message receiving server 3 of each area via internet, collects messages from all areas, also send messages to a remote display 6 for displaying, and the remote monitor server installs a memory for storing collected data to facilitate being enquired by a supervisor; and the remote monitor server 5 can send message to a cellular phone, a PDA, or other communication product of a remote supervisor, or to a notebook of a remote supervisor via a communication network, such that the supervisor, no need to stay in the front of the remote display 6, can achieve monitoring the advertising light-boxes 1 remotely;
A remote display 6, receiving messages from a remote monitor server 5 and displaying messages received, provides that a supervisor can identify which abnormal advertising light-box in which area for assigning a maintenance worker to fix it timely; the remote display 6 can be a LED panel 61, a LCD display, or both; if the display 61 of the remote display 6 is a LED panel 61, the twinkling or color of the LED can be used to indicate which advertising light-box is abnormal; if the display 62 of the remote display 6 is a LCD display 62 installed with a button 64, the LCD display 62 can be used for showing which an advertising light-box is abnormal directly, and through the button 64, enquiring the abnormal history data and printing the abnormal data via a printer for preservation; furthermore, if both the LED panel 61 and the LCD display 62 are used, then the color of the LED panel can indicate which advertising light-box is abnormal and the LCD display can show the abnormal history data; in addition, the remote display 6 not only can display the abnormal message of every advertising light-box of every area but also can sound an alarm through a speaker 63 to inform supervisor the abnormal condition of advertising light-boxes, if a supervisor not presents on the spot, the alarm of the remote display 6 can be switched off via a cellular phone, a PDA, a notebook, or other communication product to reset the remote display 6.

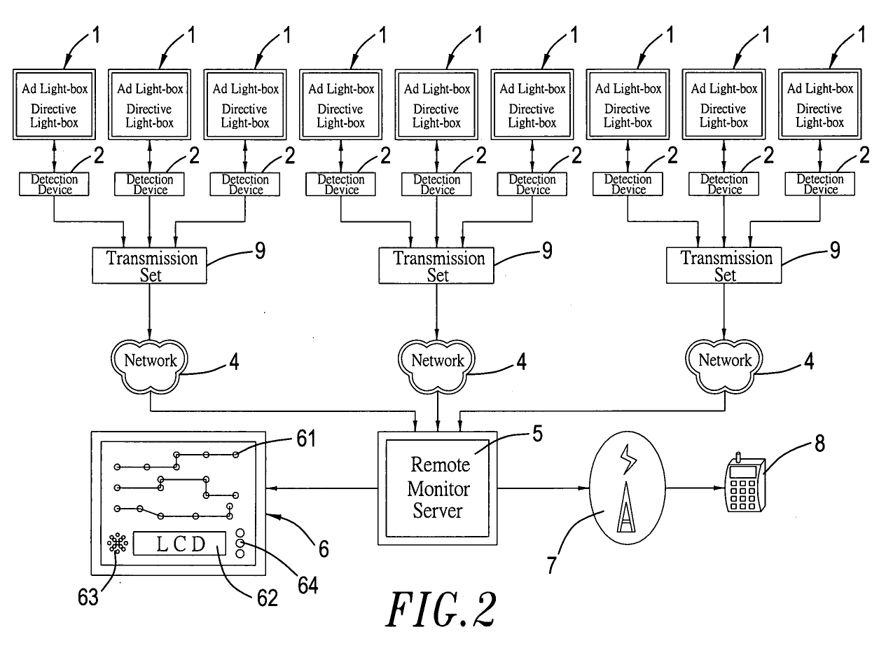

FIG. 2 shows the second architecture of a advertising light-box network system with auto-detection and auto-monitor according to the present invention, wherein a message receiving server 3 disposed in each area can be replace by a transmission set 9 such that the detection device 2 can directly transmit messages to the transmission set 9 for sending and converging messages detected to a remote monitor server 5 via internet 4; the status of each advertising light-box 1 of each area thus can be shown on the display of the remote monitor server 6, and the messages can be sent to a cellular phone, a PDA, or other communication product of a remote supervisor via a communication network 7, or alternatively sent to a notebook via internet, and thus can achieve the object of remote control and further improving the fault of the conventional checking round of advertising light-boxes. In addition, the detection device 2 can send messages in a wire or wireless way; the wireless way can be radio-frequency, infrared, Bluetooth, or other wireless transmission; the relationship between the advertising light-boxes 1, the detection device 2, the remote monitor server 5, and the remote display 6 is the same with the first architecture shown in FIG. 1, thus not described again.

As compared with other conventional techniques, the advertising light-box network system with auto-detection and auto-monitor according to the present invention has following advantages:
1. The present invention can 24-hour monitor advertising light-boxes to achieve the object of real-time maintenance.
2. The present invention can remotely monitor the advertising light-boxes to achieve the object of labor cost saving.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. An advertising light-box network system with auto-detection and auto-monitor, wherein a plurality of advertising light-boxes and a message receiving server are disposed in each area, each said advertising light-box is installed with a detection device, said detection device detects whether a lamp body, a power supply device, or a control circuit board in the advertising light-box is abnormal, and sending messages to a display of the message receiving server in each area for displaying, such that a maintenance worker can get the status of each advertising light-box in the area and the message receiving server of the area sends messages received to a remote monitor server via internet for convergence; the remote monitor server shows all messages sent from all message receiving servers on a remote display, and alarms with a light or a sound while receiving an abnormal signal so that a remote supervisor can get the status of all advertising light-boxes of all areas to achieve timely maintenance; and the remote monitor server can send messages to a cellular phone, a PDA, or a notebook of a supervisor via a communication network so that the supervisor can 24-hour monitor all advertising light-boxes in all areas.

2. The advertising light-box network system with auto-detection and auto-monitor of claim 1, wherein the detection device can send messages to a message receiving server via a wire transmission.

3. The advertising light-box network system with auto-detection and auto-monitor of claim 1, wherein the detection device can send messages to a message receiving server via a radio-frequency infrared Bluetooth or other wireless transmissions.

4. The advertising light-box network system with auto-detection and auto-monitor of claim 1, wherein the display of the message receiving server and the remote display can be a LED panel so that the supervisor can determine which advertising light-box is abnormal by the twinkling or color of the LED light.

5. The advertising light-box network system with auto-detection and auto-monitor of claim 1, wherein the display of the message receiving server and the remote display can be a LCD display so that the supervisor can determine which advertising light-box is abnormal directly and can enquire the abnormal history on the LCD display.

6. The advertising light-box network system with auto-detection and auto-monitor of claim 1, wherein the display of the message receiving server and the remote display can be a LCD display incorporated with a LED panel so that the supervisor can determine which advertising light-box is abnormal by the twinkling or color of the LED light and can enquire the abnormal history on the LCD display.

7. The advertising light-box network system with auto-detection and auto-monitor of claim 1, wherein a memory can be installed in the message receiving server to store the abnormal data of the advertising light-boxes of the area.

8. The advertising light-box network system with auto-detection and auto-monitor of claim 1, wherein the message receiving server can dispose a control button for operating and controlling the display.

9. The advertising light-box network system with auto-detection and auto-monitor of claim 1, wherein a detection loop device can be installed in the message receiving server, the detection loop device can monitor unusual conditions such as whether the detection device is normal, whether the circuit is short, and the like, to minimize the probable error.

10. The advertising light-box network system with auto-detection and auto-monitor of claim 1, wherein the remote display can facilitate enquiring the abnormal history and printing the abnormal data via a printer for preservation.

11. The advertising light-box network system with auto-detection and auto-monitor of claim 1, wherein a remote supervisor can switch off an alarm, sounded by the remote display, via a cellular phone, a PDA, a notebook, or other communication product to reset the remote display.

12. The advertising light-box network system with auto-detection and auto-monitor of claim 1, wherein a memory installed in the remote monitor server stores the collected data which can facilitate the enquiry of a supervisor.

13. An advertising light-box network system with auto-detection and auto-monitor, wherein a plurality of advertising light-boxes and a transmission set are disposed in each area; each advertising light-box installs with a detection device and said detection device detects whether a lamp body, a power supply device, or a control circuit board in the advertising light-box is abnormal, and sending messages to the transmission set in each area, and the transmission set of the area sends messages received to a remote monitor server via internet for convergence; the remote monitor server shows all messages sent from all transmission sets on a remote display and alarms with a light or a sound while receiving an abnormal signal so that a remote supervisor can get the status of all advertising light-boxes in all areas to achieve timely maintenance; and the remote monitor server can send messages to a cellular phone, a PDA, or a notebook of a supervisor via a communication network so that the supervisor can 24-hour monitor all advertising light-boxes in all areas.

14. The advertising light-box network system with auto-detection and auto-monitor of claim 13, wherein the detection device can send messages to a transmission set via a wire transmission.

15. The advertising light-box network system with auto-detection and auto-monitor of claim 13, wherein the detection device can send messages to a transmission set via a radio-frequency, infrared, Bluetooth, or other wireless transmission.

16. The advertising light-box network system with auto-detection and auto-monitor of claim 13, wherein the remote display can be a LED panel, so that a supervisor can determine which advertising light-box is abnormal by the twinkling or color of the LED light.

17. The advertising light-box network system with auto-detection and auto-monitor of claim 13, wherein the remote display can be a LCD display with a button on a panel thereof, so that a supervisor can determine which an advertising light-box is abnormal and can enquire the history abnormal data by the button, and can print the abnormal data via a printer for preservation.

18. The advertising light-box network system with auto-detection and auto-monitor of claim 13, wherein the remote display can incorporate a LCD display with a LED panel so that the supervisor can determine which advertising light-box is abnormal by the twinkling or color of the LED light and can show the history abnormal data by the LCD display and can print the abnormal data via a printer for preservation.

19. The advertising light-box network system with auto-detection and auto-monitor of claim 13, wherein a remote supervisor can switch off an alarm, sounded by the remote display, via a cellular phone, a PDA, a notebook, or other communication product to reset the remote display.

20. The advertising light-box network system with auto-detection and auto-monitor of claim 13, wherein a memory installed in the remote monitor server stores the collected data which facilitate the enquiry of a supervisor.
